(19) United States
(12) Patent Application Publication
(10) Pub. No.: US 2015/0288748 A1
(43) Pub. Date: Oct. 8, 2015

(54) METHOD AND APPARATUS FOR PROCESSING WEB INTENT MESSAGE AND EVENT IN TERMINAL USING CLOUD SERVER

(71) Applicant: SAMSUNG ELECTRONICS CO., LTD., Suwon-si (KR)

(72) Inventor: Zhang-hoon Oh, Yongin-si (KR)

(73) Assignee: SAMSUNG ELECTRONICS CO., LTD., Suwon-si (KR)

(21) Appl. No.: 14/421,660

(22) PCT Filed: Aug. 12, 2013
(86) PCT No.: PCT/KR2013/007232

§ 371 Date: Feb. 13, 2015

(30) Foreign Application Priority Data
Aug. 13, 2012 (KR) 10-2012-0088627

(51) Int. Cl. H04L 29/08; H04L 29/06

(52) U.S. Cl. CPC H04L 67/10; H04L 67/02; H04L 67/42

(57) ABSTRACT

Provided are a method of processing an event via a terminal device, a method of processing an event at a cloud server, the terminal device, and the cloud server. The method of processing an event via a terminal device includes: transmitting, to a cloud server, information regarding an event generated by a web application being executed on the terminal device; receiving a list of web applications generated by the cloud server based on the transmitted information regarding the event; and displaying the received list of web applications.

### CROSS-REFERENCE TO RELATED APPLICATIONS

This application is a National Stage application under 35 U.S.C. §371 of PCT/KR2013/007232, filed on Aug. 12, 2013, which claims priority from Korean Patent Application No. 10-2012-0088627, filed on Aug. 13, 2012 in the Korean Intellectual Property Office, all the disclosures of which are incorporated herein in their entireties by reference.

### BACKGROUND

1. Field

Apparatuses and methods consistent with exemplary embodiments relate to processing web intent messages generated by a web application being executed on a terminal device and events generated in a web browser being executed on the terminal device, by using a cloud server.

2. Description of the Related Art

When a web intent message generated by a web application being executed on a terminal device requests another web application to forward a web intent message, a controller of the terminal device may generate a list of web applications to which the web intent messages are to be transmitted based on information regarding web applications installed on the terminal device and generated web intent messages, in order to display the list of web applications on a display.

Since a web application may be executed even if the web application is not installed on a terminal device, searching for web applications including those not installed on a terminal device may cause significant loads on the terminal device. Therefore, it would be beneficial to transmit a web intent message to quickly search for a web application to execute and to generate a list of web applications, so that a user may easily select a web application to execute.

### SUMMARY

Aspects of one or more exemplary embodiments provide a method and an apparatus for processing events generated by a terminal device by using a cloud server.

According to aspects of one or more exemplary embodiments, the cloud server receives information regarding web applications installed on at least one terminal device from the terminal device, stores the information, generates a list of web applications that may be executed on the terminal device by using information regarding a web intent message received from the terminal device or web document objects included in a designated region of a web page, information regarding a history of web application selections of a user, or information regarding web application priorities, and provides the generated list of web applications to the terminal device. Here, the information regarding the web intent message may include web application executing condition information.

According to an aspect of an exemplary embodiment, there is provided a method of processing an event via a terminal device, the method including: transmitting, to a cloud server, information regarding an event generated by a web application being executed on the terminal device; receiving a list of web applications generated by the cloud server based on the transmitted information regarding the event; and displaying the received list of web applications.

The method may further include selecting, from the list of web applications, a web application to which a web intent message is to be transmitted; transmitting the web intent message to the selected web application; and inserting result data of executing the selected web application to the web application being currently executed, wherein the information regarding the event may include a web intent message including information regarding executing conditions of a web application to be executed according to the event.

The information regarding the event may include information regarding one or more web document objects included in a designated region on a web page.

The list of web applications may include estimation quality information regarding a web intent message; the estimation quality information may indicate an accuracy of estimation of a web intent message based on the one or more web document objects included in the designated region; and the web intent message may include executing conditions of a web application to be executed.

According to an aspect of another exemplary embodiment, there is provided a method of processing an event at a cloud server, the method including: receiving, from a terminal device, information regarding an event generated by a web application being executed on the terminal device; generating a list of web applications based on the received information regarding the event; and transmitting the generated list of web applications to the terminal device.

The information regarding the event may include a web intent message including information regarding executing conditions of a web application to be executed according to the event.

The information regarding the event may include information regarding one or more web document objects included in a designated region on a web page.

The list of web applications may include estimation quality information regarding a web intent message; the estimation quality information may indicate an accuracy of estimation of a web intent message based on the one or more web document objects included in the designated region; and the web intent message may include executing conditions of a web application to be executed.

The generating of the list of web applications may include: determining, by using an address of the web page, whether the information regarding one or more web document objects included in the designated region of the web page or the web intent message is stored in the cloud server; if the information regarding the one or more web document objects included in the designated region of the web page or the web intent message is stored in the cloud server, generating the list of web applications by using the information regarding the one or more web document objects or the web intent message; and if the information regarding the one or more web document objects included in the designated region of the web page or the web intent message is not stored in the cloud server, estimating a web intent message from the information regarding the one or more web document objects included in the designated region, generating the list of web applications according to the estimated web intent message, and storing the web intent message in the cloud server.

According to an aspect of another exemplary embodiment, there is provided a terminal device for processing an event, the terminal device including: a communicator configured to transmit and receive data via a network; a controller configured to transmit, to a cloud server, information regarding an event generated by a web application being executed on the terminal device and to receive, from the cloud server, a list of web applications generated by the cloud server based on the transmitted information regarding the event; and an outputter configured to display the received list of web applications.

The terminal device may further include: a storage configured to store information regarding web applications installed on the terminal device and a web intent message, wherein the controller may include: a web application manager configured to, when a web application installed on the terminal device is installed, updated, or deleted, store the web intent message regarding the web application in the storage, update the web intent message stored in the storage, or delete the web intent message stored in the storage; an event processor configured to transmit a web intent message regarding an event generated by a web application being executed on the terminal device to a could server and to receive, from the cloud server, the list of web applications generated by the cloud server based on the web intent message; and an intent service manager configured to execute a web application selected from the received list of web applications, and wherein the information regarding the event may include a web intent message including information regarding executing conditions of a web application to be executed.

The intent service manager may be configured to execute the selected web application and to insert result data thereof to the web application being executed.

According to an aspect of another exemplary embodiment, there is provided a cloud server which processes an event, the cloud server including: an event processor configured to generate a list of web applications based on information, received from a terminal device, regarding an event generated by a web application being executed on the terminal device; and a communicator configured to transmit and receive data via a network.

The information regarding the event may include information regarding one or more web document objects included in a designated region on a web page.

The cloud server may further include: a web page searcher configured to analyze information regarding the one or more web document objects of the web page and to store the analyzed information, wherein, when information regarding the one or more web document objects included in the designated region on the web page is stored a the storage, the event processor may be configured to estimate a web intent message from the information regarding the one or more web document objects and to generate the list of web applications based on the estimated web intent message, and wherein the web intent message may include information regarding executing conditions of a web application to be executed.

According to an aspect of another exemplary embodiment, there is provided a non-transitory computer readable recording medium having recorded thereon a program executable by a computer for performing either of the above methods.

### DESCRIPTION OF THE DRAWINGS

The above and other features and advantages will become more apparent by describing in detail exemplary embodiments with reference to the attached drawings in which:

FIG. 1 is a block diagram of a system for processing a web intent message or an event generated by a terminal device by using a cloud server according to an exemplary embodiment;

FIGS. 2A and 2B are block diagrams respectively showing the structure of a cloud server for processing a web intent message or an event generated by a terminal device according to one or more exemplary embodiments, and providing the processed web intent message or the processed event to the terminal device;

FIG. 3A is a block diagram showing the structure of a terminal device which processes events generated by a web application being executed thereon by using a cloud server according to an exemplary embodiment;

FIG. 3B is a block diagram showing the structure of a terminal device which processes a generated web intent message by using a cloud server, according to another exemplary embodiment;

FIG. 4 is a flowchart showing a method of processing an event, which is generated by a terminal device, by using a cloud server, according to an exemplary embodiment;

FIG. 5 is a flowchart showing a method of processing an event via a cloud server in response to a result of a terminal device, according to an exemplary embodiment;

FIG. 6 is a flowchart showing a method of processing a web intent message, which is generated by a terminal device, by using a cloud server, according to another exemplary embodiment;

FIG. 7 is a flowchart showing a method of processing a web intent message, which is generated by a terminal device, by using a cloud server, according to another exemplary embodiment;

FIG. 8 is a block diagram showing the structure of a cloud server which generates a list of web applications to be executed based on contents included in a designated region of a web page, according to another exemplary embodiment;

FIG. 9 is a block diagram showing the structure of a terminal device which generates a list of web applications to be executed according to web document objects included in a designated region on a web page by using a cloud server, according to another exemplary embodiment;

FIG. 10 is a flowchart showing a method of generating a list of web applications to be executed on a terminal device according to contents included in a designated region on a web page by using a cloud server, according to another exemplary embodiment;

FIG. 11 is a flowchart showing a method by which a cloud server generates a list of web applications to be executed based on web document objects included in a designated region on a web page in response to a request from a terminal device, according to another exemplary embodiment; and

FIGS. 12 through 15 are diagrams respectively showing examples of a method of generating a list of web applications to be executed according to a web intent message or an event, which is generated by to terminal device, by using a cloud server, according to an exemplary embodiment.

### DETAILED DESCRIPTION OF EXEMPLARY EMBODIMENTS

Hereinafter, exemplary embodiments will be described in detail with reference to the attached drawings. In the description, certain detailed explanations of related art are omitted when it is deemed that they may unnecessarily obscure the essence of the inventive concept. Like numbers refer to like elements throughout.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein. As the present inventive concept allows for various modifications and numerous exemplary embodiments, particular exemplary embodiments will be illustrated in the drawings and described in detail in the written description. However, this is not intended to limit exemplary embodiments to particular modes of practice, and it is to be appreciated that all changes, equivalents, and substitutes that do not depart from the spirit and technical scope of the present inventive concept are encompassed.

As used herein, the term “and/or” includes any and all combinations of one or more associated items. Expressions such as “at least one of,” when preceding a list of elements, modify the entire list of elements and do not modify the individual elements of the list.

A web application is an application program that may be used on a web browser via an internet or an intranet and may be executed even if the web application is not installed on a terminal device. According to an exemplary embodiment, a terminal device may transmit information regarding web application executing conditions to a cloud server and receive a list of web applications satisfying the executing conditions.

A web intent message is a message exchangeable between web applications and may include identification information regarding a web application to be executed or web application executing condition information for executing other web applications satisfying the executing conditions.

A web intent message may include web application executing condition information, that is, information regarding categories, actions, etc., of a web application. However, in a case where it is difficult to specify a particular web application to be executed from among a plurality of web applications, a web intent resolver of a terminal device may search for web applications satisfying web application executing conditions and provide a list of web applications that may be executed on the terminal device to a user. According to a user input, a selected web application may be executed.

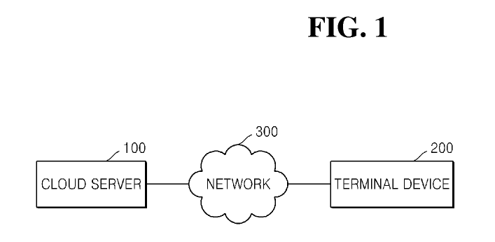

FIG. 1 is a block diagram of a system for processing a web intent message or an event generated by a terminal device by using a cloud server according to an exemplary embodiment.

Referring to FIG. 1, the system for processing a web intent message or an event generated by a terminal device 200 by using a cloud server 100 according to an exemplary embodiment may include a cloud server 100, a terminal device 200, and a network 300 such as the Internet.

The cloud server 100 receives information regarding web applications installed on at least one terminal device 200 from the terminal device 200, stores the information, generates a list of web applications that may be executed on the terminal device 200 by using information regarding a web intent message received from the terminal device 200 and/or web document objects included in a designated region of a web page, information regarding a history of web application selections of a user, and/or information regarding web application priorities, and provides the generated list of web applications to the terminal device 200. Here, the information regarding the web intent message may include web application executing condition information.

The terminal device 200 may be any of various types of user devices, e.g., a personal computer (PC), a laptop computer, a mobile phone, a tablet PC, a navigation device, a smart phone, a personal digital assistant (PDA), a smart TV, a portable multimedia player, a digital broadcasting receiver, etc.

The network 300 provides a path for transmission and reception of data between the cloud server 100 and the terminal device 200.

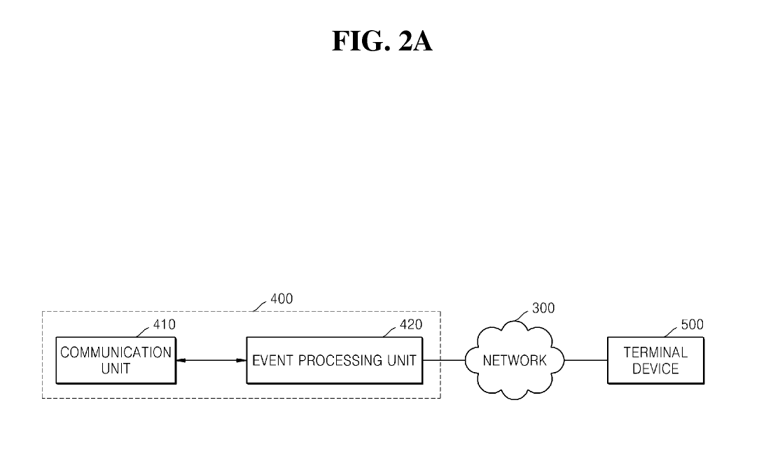

FIG. 2A is a block diagram showing the structure of a cloud server 400 for processing a web intent message or an event generated by a terminal device 500 according to an exemplary embodiment and providing the processed web intent message or the processed event to the terminal device 500.

Referring to FIG. 2A, the cloud server 400 according to an exemplary embodiment may include a communication unit 410 (e.g., communicator) and an event processing unit 420 (e.g., event processor).

According to an exemplary embodiment, the cloud server 400 processes an event generated by the terminal device 500 and provides the processed event to the terminal device 500.

The communication unit 410 exchanges data with the at least one terminal device 500 via a network.

The event processing unit 420 generates a list of web applications that may be executed on the terminal device 500 according to events by using information regarding events received from the terminal device 500 and transmits the generated list of web applications to the terminal device 500. Here, the list of web applications may further include information regarding actions to be performed when the respective web applications included in the list of web applications are selected. Therefore, when a web application to be executed is selected from the list of web applications by the terminal device 500, the web application may be executed according to the information regarding actions. Detailed descriptions of a method by which the event processing unit 420 generates a list of web applications will be given below.

According to another exemplary embodiment, the cloud server 400 processes a web intent message generated by the terminal device 500 and provides the processed web intent message to the terminal device 500.

According to another exemplary embodiment, instead of or in addition to arranging a web intent resolver in the terminal device 500, the terminal device 500 transmits a web intent message to the cloud server 400. A web intent resolver of the cloud server 400 searches for web applications satisfying conditions for the terminal device 500, generates a list of the web applications, and transmits the list of the web applications to the terminal device 500. Therefore, a list of web applications that may be executed on the terminal device 500 may be received from the cloud server 400.

Therefore, according to another exemplary embodiment, the cloud server 400 may receive, from the terminal device 500, a request including a web intent message to generate a list of web applications executable on the terminal device 500.

The event processing unit 420 may generate a list of web applications according to web application executing condition information included in a web intent message. The web intent message may include information regarding categories and/or actions of web applications to be executed on the terminal device 500. The information regarding categories may include information regarding types of web applications, e.g., web browsers, cameras, e-books, etc. The information regarding actions may include information regarding details of actions to be performed by selected web applications. The list of web applications generated by the event processing unit 420 is transmitted to the terminal device 500.

The list of web applications is generated based on information regarding web applications installed on the terminal device 500 and a web intent message. According to degrees that web applications satisfy web application executing conditions included in a web intent message, priorities of the web applications may be determined. Furthermore, the event processing unit 420 may receive additional information regarding web applications, e.g., information regarding frequencies of executing respective web applications, from the terminal device 500 and determine priorities of the web applications based on the information regarding frequencies of executing the respective web applications. Furthermore, the event processing unit 420 may determine priorities of the web applications on the list of the web applications by further considering information regarding web applications installed on terminal devices of a user, a user history of previous web application selections, and score-based rankings of the web applications.

FIG. 2B is a block diagram showing the structure of the cloud server 400 for processing a web intent message according to an exemplary embodiment. Unlike the cloud server 400 shown in FIG. 2A, the cloud server 400 shown in FIG. 2B is capable of storing information regarding installation (e.g., installation states) of web applications for each terminal device.

Referring to FIG. 2, the cloud server 400 according to another exemplary embodiment may include a communication unit 410 (e.g., communicator), an event processing unit 420 (e.g., event processor), a web application management unit 430 (e.g., web application manager), and a storage unit 440 (e.g., storage). The communication unit 410 and the event processing unit 420 shown in FIG. 2B correspond to the communication unit 410 and the event processing unit 420 shown in FIG. 2A, respectively. Therefore, any redundant descriptions thereof will be omitted below.

The web application management unit 430 receives information regarding installation of web applications for the terminal device 500 from the terminal device 500 and stores the information in the storage unit 440 of the cloud server 400. When a web application is installed on the terminal device 500, the web application management unit 430 receives information regarding installation of the web application and stores the received information in the storage unit 440. When the web application installed on the terminal device 500 is updated or deleted, the web application management unit 430 may receive information regarding the updated or deleted web application (e.g., version information) from the terminal device 500 and may update web application information stored in the storage unit 440 by using the received information.

The storage unit 440 may store the information regarding web applications installed on the terminal device 500 received by the web application management unit 430. The storage unit 440 may include any of various types of storage media, such as a random access memory (RAM), a read only memory (ROM), a hard disk drive (HDD), a flash memory, a CD-ROM, a DVD, etc.

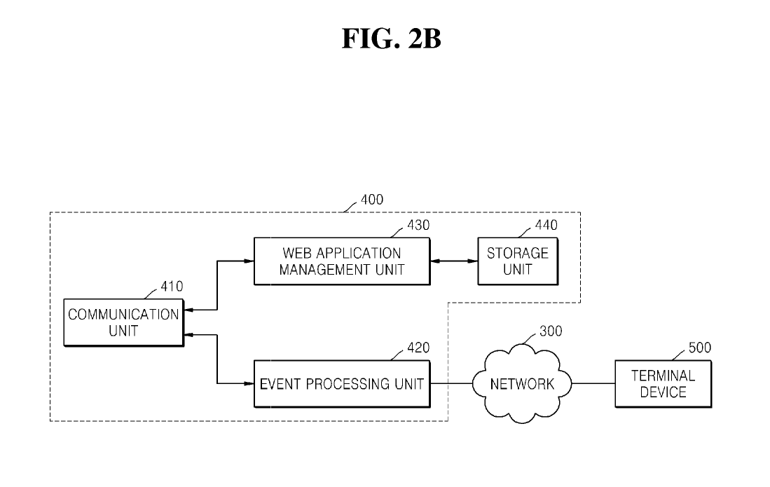

FIG. 3A is a block diagram showing the structure of a terminal device 500 which processes events generated by a web application being executed thereon by using a cloud server 400 according to an exemplary embodiment.

Referring to FIG. 3A, the terminal device 500 according to an exemplary embodiment may include a communication unit 510 (e.g., communicator), an output unit 520 (e.g., output device or outputter), and a control unit 530 (e.g., controller).

The communication unit 510 exchanges data with the cloud server 400 via a network.

The output unit 520 may display a list of web applications received from the cloud server 400. When a list of web applications is displayed by the output unit 520, a web application may be selected according to a user input, and the selected web application may be executed.

The control unit 530 controls overall operations of the terminal device 500. For example, the control unit 530 operates based on an operating system stored in a storage unit of the terminal device 500, establishes the basic platform environment of the terminal device 500, and provides arbitrary functions by executing web applications according to selections of a user.

The control unit 530 transmits information regarding events generated by a web application being currently executed to the cloud server 400 and receives a list of web applications generated based on the information regarding the events from the cloud server 400. Here, the information regarding generated events may include information regarding web application executing conditions.

FIG. 3B is a block diagram showing the structure of a terminal device 500 which processes a generated web intent message by using a cloud server 400, according to another exemplary embodiment.

Referring to FIG. 3B, the terminal device 500 according to another exemplary embodiment may include a communication unit 510 (e.g., communicator), an output unit 520 (e.g., output device or outputter), a storage unit 530 (e.g., storage), a control unit 540 (e.g., controller), and an input unit 550 (e.g., input device or inputter). The communication unit 510, the output unit 520, and the control unit 540 shown in FIG. 3B correspond to the communication unit 510, the output unit 520, and the control unit 530 shown in FIG. 3A, respectively. Therefore, any redundant descriptions thereof will be omitted below.

The storage unit 530 may store web intent messages regarding possible events that may be generated by web applications installed on the terminal device 500. Therefore, when an event is generated, the terminal device 500 may transmit a web intent message stored in the storage unit 530 to the cloud server 400 and receive a list of web applications generated according to the web intent message. The storage unit 530 may include any of various types of storage media, such as a random access memory (RAM), a read only memory (ROM), a hard disk drive (HDD), a flash memory, a CD-ROM, and a DVD.

The control unit 540 may include a web application management unit 541 (e.g., web application manager), an event processing unit 542 (e.g., event processor), and an intent service management unit 543 (e.g., intent service manager).

When a web application is installed on the terminal device 500, the web application management unit 541 may store web intent service information and web intent filter information corresponding to the installed web application in the storage unit 530. The web intent service information may include information for determining whether to generate a web intent message, whereas the web intent filter information may include condition information regarding a web application to which an web intent message will be transmitted. Here, the web intent filter information may be included in a web document of the web application. Furthermore, when a web application installed on the terminal device 500 is updated, new web intent service information and web intent filter information may be stored or existing web intent service information and web intent filter information may be updated. When a web application installed on the terminal device 500 is deleted, web intent service information and web intent filter information corresponding to the deleted web application may be deleted.

When a web application is installed on the terminal device 500 or updated, the web application management unit 541 transmits installation information regarding the web application installed on the terminal device 500 or updated to the cloud server 400. The cloud server 400 may use the installation information for generating a list of executable web applications in response to a web intent message or an event.

When a web application being executed requests to transmit a web intent message, the event processing unit 542 transmits the request to the cloud server 400. Web intent filter information may be stored in the storage unit 530 when a web application is installed on the terminal device 500. Furthermore, the event processing unit 542 may receive a list of web applications transmitted from the cloud server 400 in response to the request for transmission of the web intent message.

The intent service management unit 543 may display a list of web applications received from the cloud server 400 and execute a web application in the list of web applications selected according to a user input. Here, the list of web applications may further include information regarding actions to be performed when respective web applications are selected. The action information may be the same as or similar to action information included in a web intent message received from the terminal device 500. Therefore, when a particular web application is selected from a list of web applications on the terminal device 500, the selected web application may be executed according to the action information corresponding to the selected web application.

The input unit 550 is a unit manipulated by a user for generating user input signals for controlling and operating the terminal device 500 and may be embodied as any of various types of input devices. A user request for outputting a web page or changing a viewport may be input to the terminal device 500 via the input unit 550.

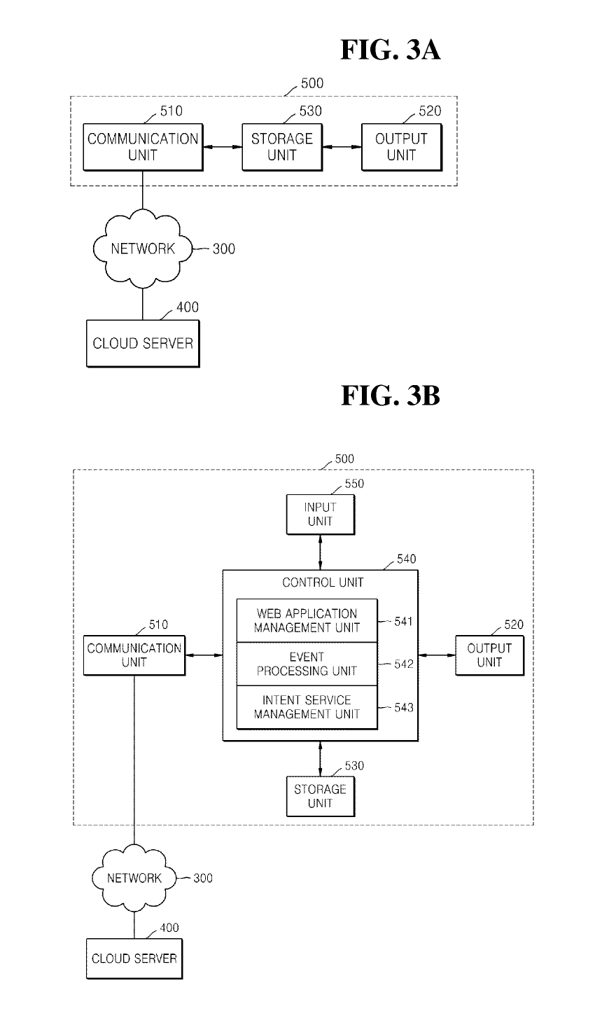

FIG. 4 is a flowchart showing a method of processing an event, which is generated by a terminal device 500, by using a cloud server 400, according to an exemplary embodiment.

Referring to FIG. 4, when an event is generated by a web application being executed on the terminal device 500, information regarding the event is transmitted to the cloud server 400 (operation S401). The information regarding the event may include information regarding executing conditions of a web application to be executed or information with which executing conditions of a web application to be executed may be estimated.

In response to the transmission in operation S401, the terminal device 500 may receive a list of web applications from the cloud server 400 (operation S403). The terminal device 500 may display the received list of web applications via the output unit 520 (operation S405), so that a web application to be executed may be selected according to a user input.

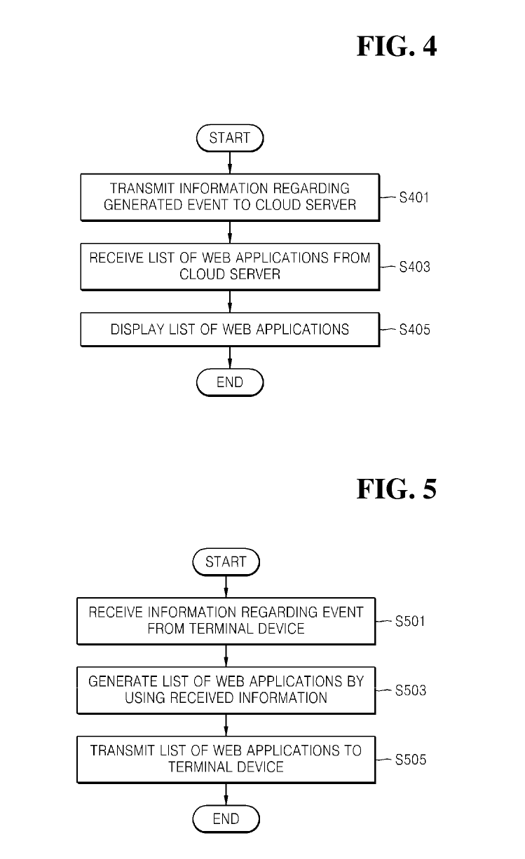

FIG. 5 is a flowchart showing a method of processing an event via a cloud server 400 in response to a result of a terminal device 500, according to an exemplary embodiment.

When the cloud server 400 receives information regarding an event from the terminal device 500 (operation S501), the cloud server 400 may generate a list of web applications by using the received information (operation S503). Here, the information regarding an event may include information regarding executing conditions of a web application to be executed and/or information with which executing conditions of a web application to be executed may be estimated

In response to the reception of the information regarding an event, the cloud server 400 transmits a generated list of web applications to the terminal device 500 (operation S505).

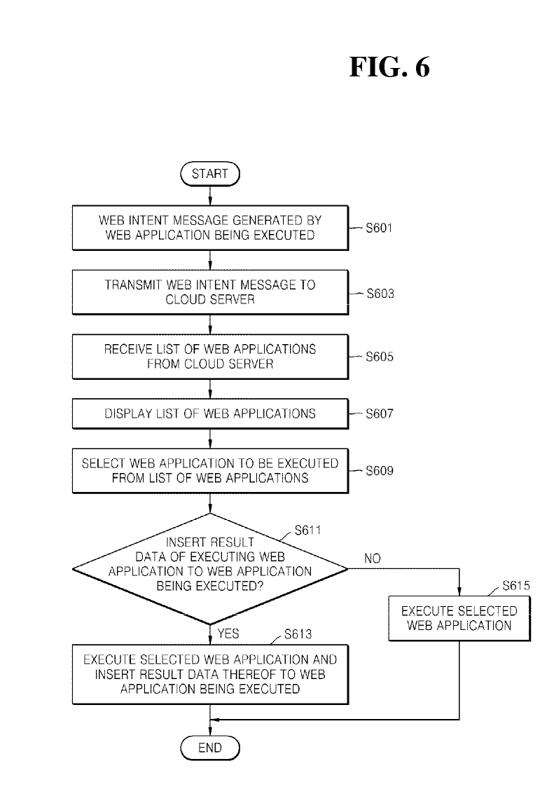

FIG. 6 is a flowchart showing a method of processing a web intent message, which is generated by a terminal device 500, by using a cloud server 400, according to another exemplary embodiment.

Referring to FIG. 6, when a web intent message is generated by a web application being executed on the terminal device 500 (operation S601), the terminal device 500 transmits, to the cloud server 400, a web intent message including information regarding executing conditions of a web application to be executed (operation S603).

In response to the transmission in operation S603, when the terminal device 500 receives a list of web applications from the cloud server 400 (operation S605), the terminal device 500 may display the list of web applications via the output unit 520 (operation S607). When a web application to be executed by transmitting a web intent message thereto is selected from the displayed list of web applications according to a user input (operation S609), the web intent message may be transmitted to the selected web application and the selected web application may be executed according to action information included in the web intent message (operation S615).

Furthermore, after a selected web application is executed, result data of executing the selected web application may be converted and inserted into the web application being executed (operation S613). For example, when a diary application being executed on the terminal device 500 is requested by a user to take a photo and to insert the photo thereto, a list of camera applications received from the cloud server 400 according to a request of the terminal device 500 may be displayed, a camera application selected according to a user input may be executed, a photo may be taken, and the photo may be inserted to the diary application.

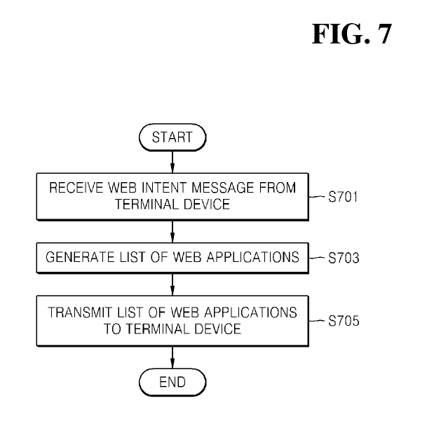

FIG. 7 is a flowchart showing a method of processing a web intent message, which is generated by a terminal device 500, by using a cloud server 400, according to another exemplary embodiment.

Referring to FIG. 7, when the cloud server 400 receives a web intent message from the terminal device 500 (operation S701), the cloud server 400 may generate a list of web applications according to the received web intent message (operation S703) and transmit the generated list of web applications to the terminal device 500 (operation S705). The cloud server 400 may determine priorities of the web applications based on at least one of the information regarding frequencies of executing the respective web applications, information regarding a user history of previous web application selections, and information regarding score-based rankings of the web applications.

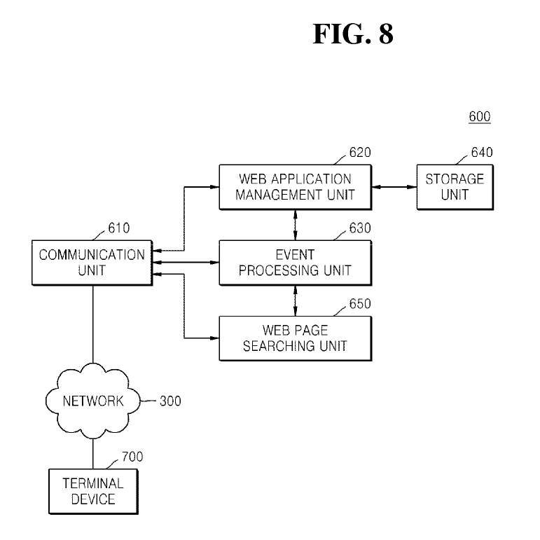

FIG. 8 is a block diagram showing the structure of a cloud server 600 which generates a list of web applications to be executed based on contents included in a designated region of a web page, according to another exemplary embodiment.

Referring to FIG. 8, the cloud server 600 may include a communication unit 610 (e.g., communicator), a web application management unit 620 (e.g., web application manager), an event processing unit 630 (e.g., event processor), a storage unit 640 (e.g., storage), and a web page searching unit 650 (e.g., web page searcher). The communication unit 610, the web application management unit 620, the event processing unit 630, and the storage unit 640 may correspond to the communication unit 410, the web application management unit 430, the event processing unit 420, and the storage unit 440 shown in FIG. 2B, respectively. Therefore, any redundant descriptions thereof will be omitted below.

For the cloud server 600 to determine whether a web application may be executed on a terminal device 700, the web application management unit 620 may receive not only information regarding web applications installed on the terminal device 700, but also device information of the terminal device 700 from the terminal device 700 and store the device information in the storage unit 640 of the cloud server 600. Furthermore, the web application management unit 620 may store information regarding the web application.

The event processing unit 630 generates a list of web applications that may be executed on the terminal device 700 according to web document objects included in a designated region of a web page by using information regarding an event received from the terminal device 700, the information stored in the storage unit 640 of the cloud server 600 regarding the web applications installed on the terminal device 700, the device information regarding the terminal device 700, and the information regarding the web application and transmits the generated list of web applications to the terminal device 700.

The event processing unit 630 may estimate (e.g., predict, calculate, or determine) a web intent message from web document objects included in the designated region on the web page of the terminal device 700 and generate a list of web applications according to the estimated web intent message.

If content included in the designated region is a photo, the event processing unit 630 may generate a web intent message including category information indicating ‘share’ and action information indicating execution of a photo share service of a social networking service (SNS) application and generate a list of web applications according to the generated web intent message. Furthermore, the event processing unit 630 may generate a plurality of web intent messages including different category information and different action information and generate a plurality of lists of web applications according to the respective web intent messages.

When a list of web applications is generated, the event processing unit 630 may generate estimation quality information regarding the web intent message and include the estimation quality information regarding the web intent message in the list of web applications. Here, the estimation quality information indicates accuracy of estimation of a web intent message based on web document objects included in a designated region of a web page.

If an estimation quality regarding a web intent message is below or equal to a critical value (e.g., predetermined value), the event processing unit 630 may request the terminal device 700 to re-designate a region.

The cloud server 600 may use the average of estimation quality values regarding at least one web intent message or the lowest estimation quality value from among estimation quality values regarding a plurality of web intent messages as an estimation quality value for determining whether to request re-designation of a region and may compare the average value or the lowest estimation quality value to a critical value.

If a designated region on a web page is small, a small estimation quality value may be obtained. For example, when a web document object included in a designated region on a web page is texts and the designated region on the web page is small, the number of the texts in the designated region on the web page would be small. Therefore, a low estimation quality value may be obtained. Accordingly, the event processing unit 630 may request the terminal device 700 to designate a larger region on the web page.

Furthermore, the event processing unit 630 may further consider estimation quality information for determining priorities of web applications in a list of web applications.

The web page searching unit 650 may browse through the worldwide web (WWW) by using an organized and automated method like a web crawler and may generate copies of all visited web pages. The web page searching unit 650 may analyze web document objects included in web pages by using the generated copies. Therefore, when a web intent message is estimated for generating a list of web applications, information regarding the analyzed web document objects may be used. Furthermore, when a web intent message is estimated to generate a list of web applications to be executed with respect to a designated region on a web page in response to a request of the terminal device 700, the web page searching unit 650 stores the estimated web intent message in the storage unit 640 and may use the stored web intent message when the event processing unit 630 receives a request for generating a list of web applications from the terminal device 700 with respect to the same web page.

The event processing unit 630 may store information regarding web applications installed on the terminal device 700 by the web application management unit 620, device information regarding the terminal device 700, copies of web pages searched by the web page searching unit 650, and web intent messages estimated during generation of lists of web applications.

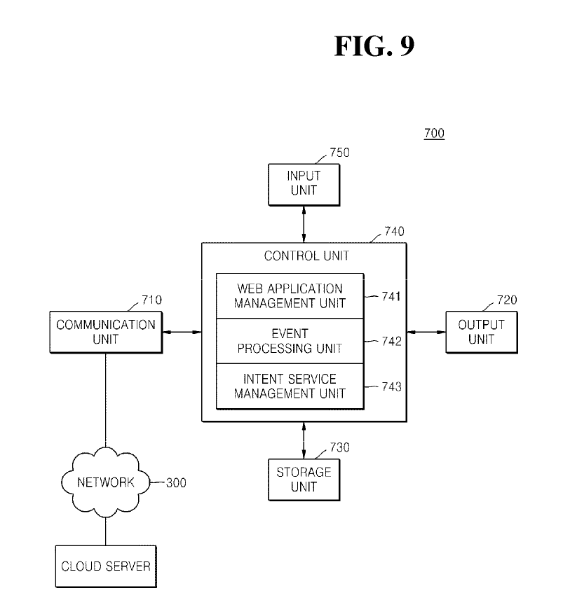

FIG. 9 is a block diagram showing the structure of a terminal device 700 which generates a list of web applications to be executed according to web document objects included in a designated region on a web page by using a cloud server 600, according to another exemplary embodiment.

Referring to FIG. 9, the terminal device 700 according to the present exemplary embodiment may include a communication unit 710 (e.g., communicator), an output unit 720 (e.g., output device or outputter), a storage unit 730 (e.g., storage), a control unit 740 (e.g., controller), and an input unit 750 (e.g., input device or inputter). The communication unit 710, the output unit 720, the storage unit 730, the control unit 740, and the input unit 750 shown in FIG. 9 correspond to the communication unit 510, the output unit 520, the storage unit 530, the control unit 540, and the input unit 550 shown in FIG. 3B, respectively. Therefore, any redundant descriptions thereof will be omitted below. Furthermore, a web application management unit 741 (e.g., web application manager), an event processing unit 742 (e.g., event processor), and an intent service management unit 743 (e.g., intent service manager) shown in FIG. 9 correspond to the web application management unit 541, the event processing unit 542, and the intent service management unit 543 shown in FIG. 3B, respectively. Therefore, any redundant descriptions thereof will be omitted below.

The event processing unit 742 may request a cloud server 600 to generate a list of related web applications by analyzing web document objects included in a designated region on a web page according to a user input and to transmit the generated list of web applications to the terminal device 700. Here, the event processing unit 742 may transmit information regarding the designated region on the web page and address information regarding the web page to the cloud server 600.

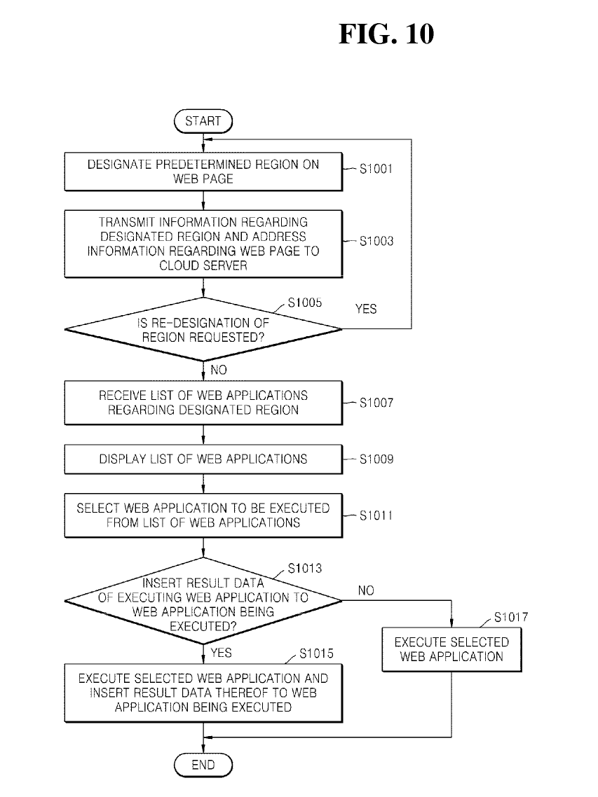

FIG. 10 is a flowchart showing a method of generating a list of web applications to be executed on a terminal device 700 according to contents included in a designated region on a web page by using a cloud server 600, according to another exemplary embodiment.

Referring to FIG. 10, when a region is designated on a web page displayed in a web browser being executed on the terminal device 700 according to a user input (operation S1001), the terminal device 700 transmits information regarding the designated region and address information regarding the web page to the cloud server 600 (operation S1003) and requests the cloud server 600 to analyze web document objects included in the designated region and to transmit a list of web applications to be executed.

Here, when the terminal device 700 is requested by the cloud server 600 to re-designate a region (operation S1005), the terminal device 700 may re-designate a region and transmit the related information to the cloud server 600.

The terminal device 700 may receive a list of web applications regarding the designated region on the web page from the cloud server 600 (operation S1007), display the list of web applications via the output unit 720 (operation S1009), and select a web application to be executed according to a user input (operation S1011). The selected web application may be executed according to action information of a web intent message corresponding to each web application (operation S1017). Furthermore, after the selected web application is executed, result data of executing the selected web application may be converted and inserted to the web application being executed (operations S1013 and S1015).

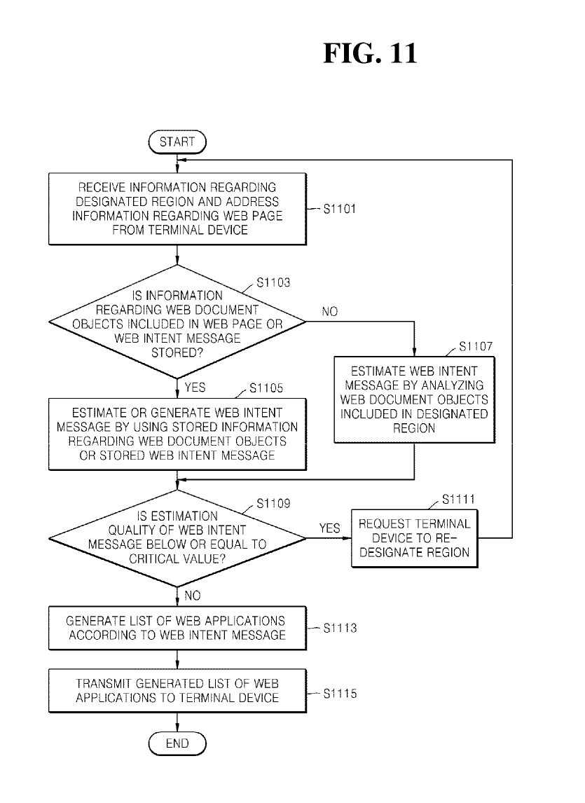

FIG. 11 is a flowchart showing a method by which a cloud server 600 generates a list of web applications to be executed based on web document objects included in a designated region on a web page in response to a request from a terminal device 700, according to another exemplary embodiment.

Referring to FIG. 11, the cloud server 600 receives information regarding a designated region on a web page and address information regarding the web page from the terminal device 700 (operation S1101), and determines whether content information or a web intent message regarding the web page generated by the web page searching unit 650 is stored (operation S1103). The cloud server 600 may estimate and/or generate at least one web intent message regarding the designated region on the web page by using the stored content information or the stored web intent message (operation S1105).

If no information regarding the web page is stored, the cloud server 600 may analyze web document objects included in the web page and estimate a web intent message (operation S1107).

If an estimation quality regarding a web intent message is below or equal to a critical value (operation S1109), the cloud server 600 may request the terminal device 700 to re-designate a region on the web page (operation S1111). Here, the cloud server 600 may set a limit in a number of times for requesting the terminal device 700 to re-designate a region or may inquire from a user of the terminal device 700 whether to re-designate a region.

If an estimation quality regarding a web intent message is not below or equal to a critical value, the cloud server 600 may generate a list of web applications according to a web intent message (operation S1113) and transmit the list of web applications to the terminal device 700 (operation S1115).

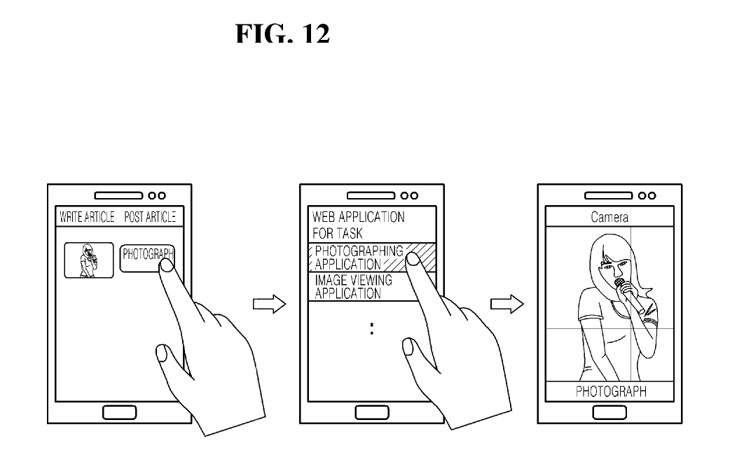

FIGS. 12 through 15 are diagrams showing respective examples of a method of generating lists of web applications to be executed according to events, which are generated by a terminal device 500, by using a cloud server 600, according to an exemplary embodiment.

According to another exemplary embodiment, as shown FIG. 12, if a photographing button is tapped on the terminal device 500 to insert a photo to a web application being executed on the terminal device 500, the terminal device 500 may transmit a web intent message regarding the photographing operation to the cloud server 400 and may receive a list of web applications in response thereto. The terminal device 500 may take a photograph by using a web application selected according to a user input and may insert the taken photograph to the web application being executed.

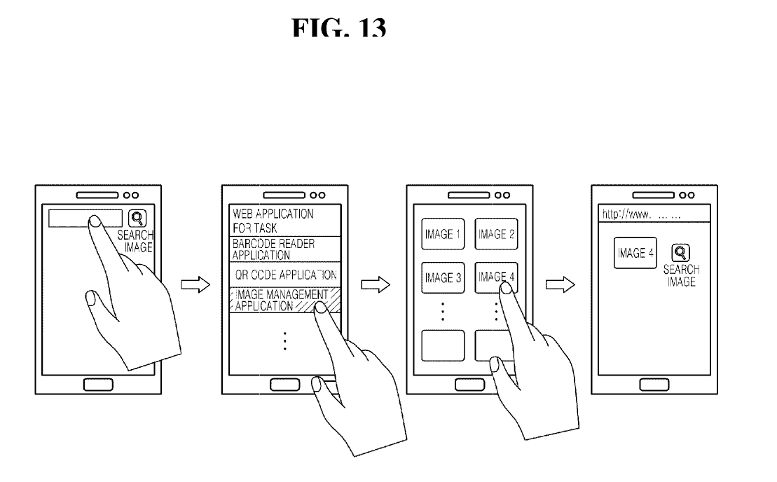

According to another exemplary embodiment, as shown in FIG. 13, when a web application being executed on the terminal device 500 to insert an image for performing an image searching operation, the terminal device 500 may transmit a web intent message regarding the request for inserting an image to the cloud server 500, may receive a list of web applications in response thereto, and display the list of web applications. The terminal device 500 may search for and select an image stored in the terminal device 500 by using a web application selected according to a user input and insert the selected image to the web application being executed.

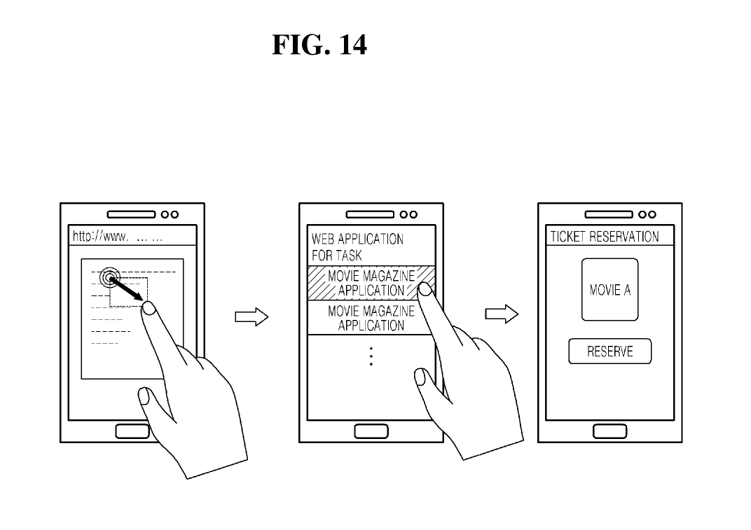

According to another exemplary embodiment, as shown in FIG. 14, when a region including a text indicating ‘a movie A released on Apr. 5, 2012 is playing in a movie theatre B’ is designated on a web page displayed on a terminal device 600 and execution of a related web application is requested, the terminal device 600 may request a cloud server 700 to generate a list of web applications and transmit the list of web applications to the terminal device 600. Here, the terminal device 600 may transmit information regarding web document objects including texts in the designated region to the cloud server 700. The cloud server 700 analyzes content information included in the designated region on the web page, e.g., current date, name of the theatre, name of the movie, etc., set priorities of web applications based on a result of the analysis, and generate a list of web applications related to the designated region on the web page. When a web application for making movie ticket reservations provided by the theatre B is selected according to a user input, the cloud server 700 may reserve tickets for the movie A by using the selected web application.

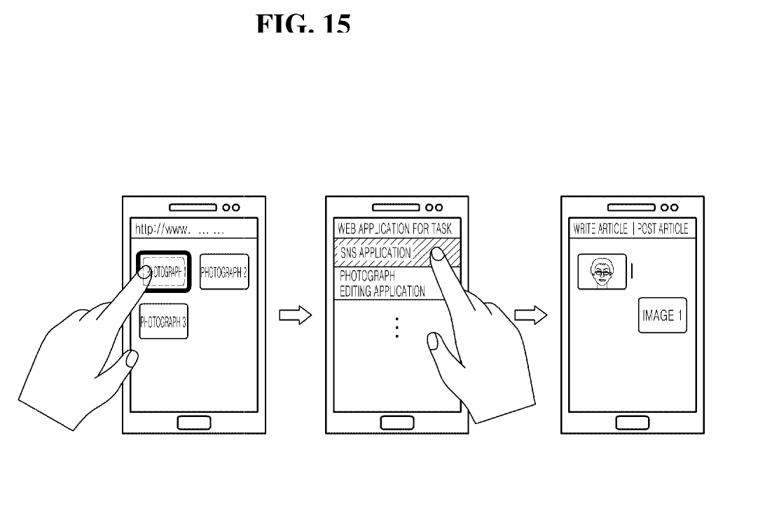

According to another exemplary embodiment, as shown in FIG. 15, when a region is designated on a web page displayed on the terminal device 600 to include an image and execution of a related web application is requested, the terminal device 600 may request the cloud server 700 to generate a list of web applications and transmit the list of web applications to the terminal device 600. If a plurality of images are included in the designated region, the cloud server 700 may set the first priority to a SNS web application capable of sharing images or photos and generate a list of web applications. If only a portion of an image is included in the designated region, the cloud server 700 may set the first priority to a photo editing web application and generate a list of web applications. When a web application to be executed on the cloud server 700 is selected from the list of web applications, the cloud server 700 may execute the selected web application and share or edit the image(s) included in the designated region.

One or more exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. Furthermore, it is understand that one or more units of the above-described devices and servers may be implemented as software and/or hardware (e.g., at least one processor, a memory, circuitry, etc.).

While exemplary embodiments have been particularly shown and described above, it will be understood by those of ordinary skill in the art that various changes in form and details may be made therein without departing from the spirit and scope of the present invention as defined by the following claims.

1. A method of processing an event via a terminal device, the method comprising:
transmitting, to a cloud server, information regarding an event generated by a web application being executed on the terminal device;
receiving a list of web applications generated by the cloud server based on the transmitted information regarding the event; and
displaying the received list of web applications.

2. The method of claim 1, further comprising:
selecting, from the list of web applications, a web application to which a web intent message is to be transmitted;
transmitting the web intent message to the selected web application; and
inserting result data of executing the selected web application to the web application being currently executed,
wherein the information regarding the event comprises a web intent message comprising information regarding executing conditions of a web application to be executed according to the event.

3. The method of claim 1, wherein the information regarding the event comprises information regarding one or more web document objects included in a designated region on a web page.

4. The method of claim 3, wherein:
the list of web applications comprises estimation quality information regarding a web intent message;
the estimation quality information indicates an accuracy of estimation of a web intent message based on the one or more web document objects included in the designated region; and
the web intent message comprises executing conditions of a web application to be executed.

5. A method of processing an event at a cloud server, the method comprising:
receiving, from a terminal device, information regarding an event generated by a web application being executed on the terminal device;
generating a list of web applications based on the received information regarding the event; and
transmitting the generated list of web applications to the terminal device.

6. The method of claim 5, wherein the information regarding the event comprises a web intent message comprising information regarding executing conditions of a web application to be executed according to the event.

7. The method of claim 5, wherein the information regarding the event comprises information regarding one or more web document objects included in a designated region on a web page.

8. The method of claim 7, wherein:
the list of web applications further comprises estimation quality information regarding a web intent message;
the estimation quality information indicates an accuracy of estimation of a web intent message based on the one or more web document objects included in the designated region; and
the web intent message comprises executing conditions of a web application to be executed.

9. The method of claim 8, wherein the generating of the list of web applications comprises:
determining, by using an address of the web page, whether the information regarding one or more web document objects included in the designated region of the web page or the web intent message is stored in the cloud server;
if the information regarding the one or more web document objects included in the designated region of the web page or the web intent message is stored in the cloud server, generating the list of web applications by using the information regarding the one or more web document objects or the web intent message; and
if the information regarding the one or more web document objects included in the designated region of the web page or the web intent message is not stored in the cloud server, estimating a web intent message from the information regarding the one or more web document objects included in the designated region, generating the list of web applications according to the estimated web intent message, and storing the web intent message in the cloud server.

10. A terminal device for processing an event, the terminal device comprising:
a communicator configured to transmit and receive data via a network;
a controller configured to transmit, to a cloud server, information regarding an event generated by a web application being executed on the terminal device to receive, from the cloud server, a list of web applications generated by the cloud server based on the transmitted information regarding the event; and
an outputter configured to display the received list of web applications.

11. The terminal device of claim 10, further comprising:
a storage configured to store information regarding web applications installed on the terminal device and a web intent message,
wherein the controller comprises:
a web application manager configured to, when a web application installed on the terminal device is installed, updated, or deleted, store the web intent message regarding the web application in the storage, updates the web intent message stored in the storage, or deletes the web intent message stored in the storage;
an event processor configured to transmits a web intent message regarding an event generated by a web application being executed on the terminal device to a could server and to receive, from the cloud server, the list of web applications generated by the cloud server based on the web intent message; and
an intent service manager configured to execute a web application selected from the received list of web applications, and
wherein the information regarding the event comprises a web intent message including information regarding executing conditions of a web application to be executed.

12. The terminal device of claim 11, wherein the intent service manager is configured to execute the selected web application and to insert result data thereof to the web application being executed.

13. A cloud server which processes an event, the cloud server comprising:
an event processor configured to generate a list of web applications based on information, received from a terminal device, regarding an event generated by a web application being executed on the terminal device; and
a communicator configured to transmit and receive data via a network.

14. The cloud server of claim 13, wherein the information regarding the event comprises information regarding one or more web document objects included in a designated region on a web page.

15. The cloud server of claim 14, further comprising:
a web page searcher configured to analyze information regarding the one or more web document objects of the web page and to store the analyzed information,
wherein, when information regarding the one or more web document objects included in the designated region on the web page is stored a the storage unit, the event processor is configured to estimate a web intent message from the information regarding the one or more web document objects and to generate the list of web applications based on the estimated web intent message, and
wherein the web intent message comprises information regarding executing conditions of a web application to be executed.

16. A non-transitory computer readable recording medium having recorded thereon a program executable by a computer for performing the method of claim 1.

17. A non-transitory computer readable recording medium having recorded thereon a program executable by a computer for performing the method of claim 5.
